(19) United States
(12) Patent Application Publication
(10) Pub. No.: US 2006/0221025 A1
(43) Pub. Date: Oct. 5, 2006

(54) Arrangement comprising a look-up table of an LCD display module

(75) Inventors: Achim Breunig, Seltz (FR); Uwe Nagel, Karlsruhe (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/397,441

(22) Filed: Apr. 4, 2006

(30) Foreign Application Priority Data
Apr. 4, 2005 (DE) 10 2005 015 419.0

(51) Int. Cl. G09G 3/36

(52) U.S. Cl. 345/87

(57) ABSTRACT

An arrangement comprising a look-up table of an LCD display module is proposed, to which look-up table video input values can be fed, the look-up table assigning video output values to the video input values and feeding the video output values to an LCD display of the LCD display module. Through appropriate measures, a large number of test patterns for calibration procedures can be processed and displayed on the LCD display.

### CROSS REFERENCE TO RELATED APPLICATIONS

This application claims priority to the German application No. 10 2005 015 419.0, filed Apr. 4, 2005 which is incorporated by reference herein in its entirety.

### FIELD OF INVENTION

The invention relates to an arrangement comprising a look-up table of an LCD display module, to which video input values can be fed, the look -up table assigning video output values to the video input values and feeding these video output values to an LCD display of the LCD display module.

### BACKGROUND OF INVENTION

In the medical field, in particular, the requirements for an image reproduction system are extremely high in terms of the image reproduction characteristics of this system, e.g. of a panel of a flat screen. The image reproduction characteristics indicate how an electrical image signal is converted into an optical signal, consisting of luminance and chrominance. It is, for example, required that luminance increase equidistantly in perception terms as a function of a video input signal (a video level). Equidistantly in perception terms means that the human eye perceives the image e.g. at a video level of 50% of its maximum value to be half as bright as the image with a video level of 100%. In order to achieve this, measures are required in order to adapt the course of luminance characteristics to the sensitivity of the human eye.

### SUMMARY OF INVENTION

The luminance characteristics can be adapted with the aid of a look-up table, as it is called. The correction is made in that a graphics processor suitable for controlling a panel of a flat screen inputs firstly video input values and video output values assigned to these video input values in a look-up table. Which video output value is then given to the panel depends on the video input value, by which means a luminance can be adjusted in accordance with desired luminance characteristics. In other words, the correction occurs in the manner in which the digitalized image is evaluated by means of the look-up table; instead of a video input value, a video output value assigned to this video input value is written to the panel.

In this way, it is possible to adapt the image reproduction characteristics via the look-up table such that e.g. these characteristics conform to the DICOM standard. According to this standard, the luminance range from 0.05 cd/m² to 4,000 cd/m² is subdivided into 1,024 steps Oust noticeable differences) so that the luminance difference between the individual steps is just perceptible to the eye. By this means, the luminance increases evenly in perception terms.

In order to calibrate the luminance characteristics e.g. in accordance with this DICOM standard, a large number of test images are required which each represent a test pattern. For example, approx. 33 grey levels have to be calibrated for the foreground and approximately 50 grey levels for the background, a suitable measurement head recording the luminances during this calibration. A suitable calibration program that is capable of running on a personal computer calculates video output values from the video input values, the recorded luminances and the target luminances according to DICOM and stores these in the look-up table.

Due to the large number of test images which are generated by a suitable graphics card of a computer, adequate memory capacity is necessary, as a result of which not all the test images required can be stored in an FPGA module or in a display store of the LCD display module.

An object of the present invention is to create an arrangement for testing an LCD display by means of which a large number of test patterns can be generated for calibration procedures or for checking the image quality. At the same time, the use of a graphics card should be dispensed with.

This object is achieved by the claims.

The invention proceeds from the idea that only a coded test image is needed in order to generate a large number of individual test patterns, i.e. a large number of individual decoded test images that can be represented on a panel, whereby these test patterns can be decoded by a look-up table regularly available in LCD display modules. A look-up table usually has 256 correction points, through which e.g. 256 graphics elements are addressable. In the event that this look-up table has an 8-bit resolution, each element can be displayed in 256 grey levels and/or in the case of a color display module in 2²⁴ colors.

In an embodiment of the invention according to the measures specified in claim 2, it is provided that a computer, a PDA or a mobile telephone generates at least one control instruction in accordance with a user input or automatically. This simplifies field calibration, whereby a service engineer is able to call up special test patterns or to activate a calibration program which calls up in succession different test patterns required for calibration. Particularly where a mobile telephone or a PDA is used, the communication interface can be fashioned as a Bluetooth interface.

Further advantageous embodiments of the invention will emerge from the dependent claims.

### BRIEF DESCRIPTION OF THE DRAWINGS

With the aid of the drawings in which an exemplary embodiment of the invention is illustrated, the invention and embodiments and advantages thereof are explained in detail below.

FIG. 1 shows an arrangement for controlling an LCD display and

FIGS. 2 to 4 show various test patterns which can be displayed on an LCD display.

### DETAILED DESCRIPTION OF INVENTION

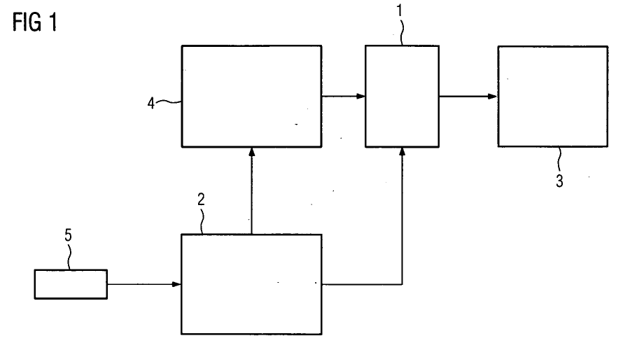

In FIG. 1, a look-up table to which the video input steps of a controller 2 can be fed is labeled 1. The controller 2 can be an integral part of a graphics processor, to which during normal operating mode image signals are transmitted. The graphics processor processes the image signals, said graphics processor transmitting the processed signals in the form of video input steps to the look-up table 1. the look-up table 1 evaluates the video input steps for optimizing the image reproduction characteristics and applies video output steps assigned to the video input steps to an LCD display 3.

In order to generate a plethora of test patterns (decoded test images) from a coded test image for calibration procedures during a calibration phase, there is provided in the present exemplary embodiment a memory 4 in which the test image can be stored. The memory 4 and the controller 2 as well as the look-up table 1 and the LCD display 3 are integral components of an LCD display module. The test image is input in the memory 4 e.g. by a computer not shown here, e.g. a computer in the form of a personal computer, a PDA (Personal Digital Assistant) or a mobile telephone, via a suitable communication interface 5. The transfer of the test image is displayed to the controller 2 by a control instruction transmitted via the communication interface 5. It is, of course, possible to transfer the test image firstly to the controller 2 which writes the test image into the memory 4. It is also possible to store the coded test image, for example, in an EEPROM of the arrangement, as a result of which transfer of the test image to the arrangement is dispensed with and the calibration procedure shortened. Furthermore, it is conceivable to store not the complete test image but only such data as is required in order to generate the test image. In this case, the memory requirement in the arrangement is reduced, in that in order to generate the test image of the arrangement only an instruction for generating the test image via the communication interface 5 is transmitted, and a suitable program in the controller 2 generates the test image.

A user selects, directed by a menus, via a selection program which is capable of running on the personal computer a test pattern, by means of which the selection program generates a further control instruction and transmits it to the controller 2 via the communication interface 5. Depending on this control instruction, the controller 2 loads the look-up table 1 with video output values with which a test pattern of the test image—as will be shown below—is decoded. The test patterns can also be selected automatically, whereby in this case calibration software selects and displays on the LCD display 3 different test patterns e.g. in succession. The luminances of the test patterns can e.g. be recorded and analyzed in order to optimize the image reproduction characteristics.

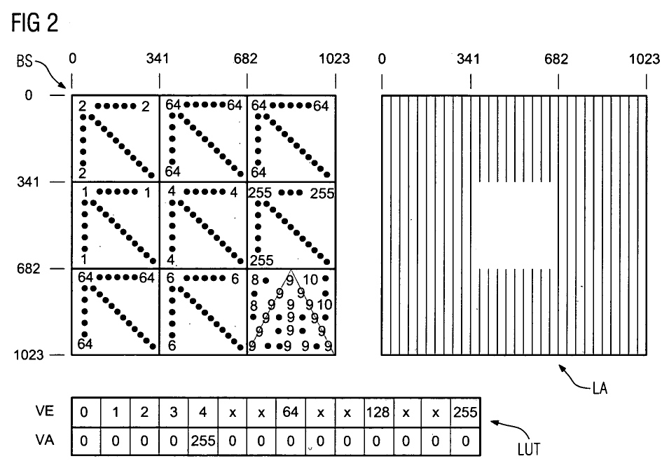

Reference is made below to FIGS. 2 to 4 in which different test patterns which can be displayed on an LCD display are shown.

It is assumed that a coded test image stored in a display store BS can be displayed on a monochrome LCD display with a resolution of 1024×1024 pixels. It is also assumed, for the sake of simplicity, that an 8-bit look-up table LUT is provided for evaluating the video input steps, as a result of which 256 graphics elements, e.g. elements in the form of a square, a triangle or a circle, can be arranged in the test image and displayed in any grey level or color. For the sake of simplicity, in the present example only a coded monochrome test image is stored in the display store BS. In the event that an element is to be displayed in color, for each video input value a video output value has to be provided for each R, G and B elementary color.

In FIG. 2, video output values VA are assigned to video input values VE in a look-up table LUT loaded by the controller 2. The video output value 255 is assigned to the video input value 4, while the video output value 0 is assigned to each of the remaining video input values. This means that the memory content of the display store BS coded with the value 4 is displayed white on an LCD display LA (pixel range from 341 to 682). By contrast, the memory content of the display store BS which is not coded with the value 4 is displayed black on the LCD display LA (remaining range), which is shown in the Figures by vertical lines.

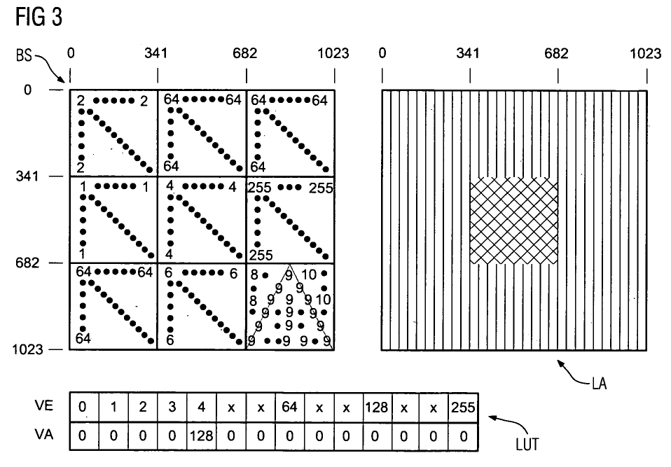

In the example according to FIG. 3, the video input value 4 is again stored in the memory cells which correspond to pixels 341 to 682 of the LCD display LA (same coded test image). According to the population of the look-up table LUT, the video output value 128 is assigned to this video input value, as a result of which a test pattern in the form of a grey square (shown hatched) is displayed in the range of pixels from 341 to 682 and the remaining pixel range of the LCD display LA is displayed black.

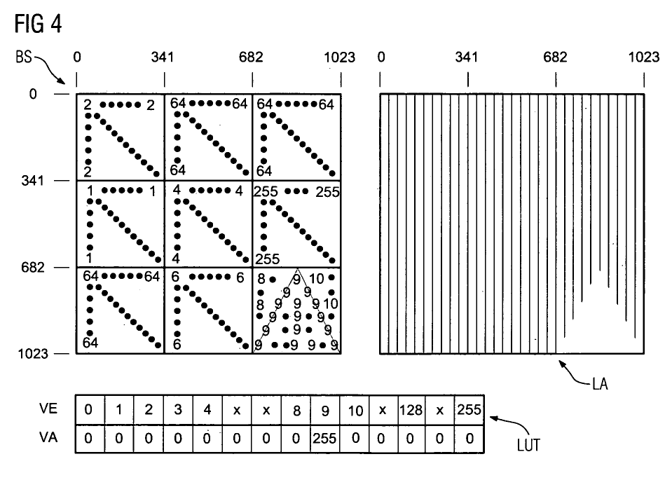

Based on the allocation of the display store BS and of the look-up table LUT according to FIG. 4, in which the video output value 255 is assigned to the video input value 9 and the video output value 0 to the remaining video input values, a white triangle is decoded as a test pattern in the test image in a pixel range from 682 to 1023 and displayed on the LCD display LA, the remaining pixel range of the LCD display LA again being shown black.

1-4. (canceled)

5. An arrangement for testing an LCD display module having an LCD display, comprising:
a look-up table having video input values and assigning video output values to the video input values, the video output values fed to the LCD display;
a test picture having a plurality of test patterns, the test picture stored in or generated by the arrangement; and
a controller configured to receive via a communication interface at least one control command during a calibration phase, the control command triggering the controller to allocate specific video output values to the look-up table, the specific video output values configured to select at least one of the test patterns from the test picture.

6. The arrangement according to claim 5, wherein the control command is generated by a computer, a PDA or a mobile telephone upon a user input.

7. The arrangement according to claim 5, wherein the control command is automatically generated by a computer, a PDA or a mobile telephone.

8. The arrangement according to claim 6, wherein the computer, PDA or mobile telephone generates a further control instruction for loading the test picture onto the arrangement upon the or a further user input.

9. The arrangement according to claim 7, wherein the computer, PDA or mobile telephone generates a further control instruction for loading the test picture onto the arrangement upon the or a further user input.

10. The arrangement according to claim 8, wherein the further control instruction is generated by actuating at least one key of the LCD display module or by activating an OSD function of the LCD display module.

11. The arrangement according to claim 9, wherein the further control instruction is generated by actuating at least one key of the LCD display module or by activating an OSD function of the LCD display module.
